(19) United States
(12) Patent Application Publication
(10) Pub. No.: US 2009/0126689 A1
(43) Pub. Date: May 21, 2009

(54) Fuel injector having valve with opposing sealing surfaces

(75) Inventor: Dennis Henderson Gibson, Chillicothe, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/984,379

(22) Filed: Nov. 16, 2007

(51) Int. Cl. F02M 57/00

(52) U.S. Cl. 123/446

(57) ABSTRACT

A control valve for a fuel injector is disclosed. The fuel injector has a nozzle member with a first end and a second end. The first end of the nozzle member has at least one orifice. In addition, the fuel injector has a drain passageway. The fuel injector also has a control chamber located at the second end of the nozzle member and at least one passageway fluidly coupled to the control chamber. The fuel injector further has a needle valve element with a tip end configured to selectively block fluid flow through the at least one orifice, and a base end fluidly coupled to the control chamber. In addition, the fuel injector has a control valve with a first generally planar surface and a second opposing generally planar surface. The control valve is selectively movable between a first position and a second position. When the control valve is in the first position, the control chamber is fluidly block from the drain passageway. When the valve is in the second position, the control chamber is fluidly coupled to the drain passageway.

### TECHNICAL FIELD

The present disclosure is directed to a fuel injector and, more particularly, to a fuel injector having a valve with opposing sealing surfaces.

### BACKGROUND

Fuel injectors provide a way to introduce fuel into the combustion chambers of an engine. One type of fuel injector is known as the common rail fuel injector. A typical common rail fuel injector includes a nozzle assembly having a cylindrical bore with a nozzle outlet at one end, and a nozzle supply passageway fluidly coupled to a high pressure fuel rail at an opposite end. A needle check valve is reciprocatingly disposed within the cylindrical bore and spring-biased toward a closed position at which the nozzle outlet is blocked. To inject fuel, the needle check valve is moved to open the nozzle outlet, thereby allowing high pressure fuel to travel from the high pressure rail through the nozzle supply passageway and spray into the associated combustion chamber.

The needle check valve is movable between the open and closed positions, which movement is at least partially controlled by the selective draining and filling of a control chamber associated with a base of the needle check valve. In particular, the control chamber may be filled with pressurized fuel to retain the needle check valve in a closed position, and selectively drained of the pressurized fuel to allow the pressure at a tip end of the needle check valve to urge the needle check valve toward the open position.

A valve actuated by a piezo device is often hydraulically coupled to the control chamber to affect draining and filling of the control chamber. Specifically, the piezo device is typically mechanically connected to a first piston, which is separated from a second piston by a space filled with fluid. This space forms a coupling chamber that is used to accommodate manufacturing tolerances, heat expansion of the injector components, and/or amplification of force or movement of the piezo device. As the piezo device is charged and expands to move the first piston, the fuel within the coupling chamber displaces, resulting in movement of the second piston. The second piston then presses against and opens a control valve, thereby draining the control chamber.

Prior valve assembly designs used in the common rail fuel injector included a spherical valve member and a complimentary conical annular seating surface. Although somewhat successful, the spherical valve member and conical seat required high precision and expensive machining processes.

One attempt at addressing the shortcomings described above is disclosed in U.S. Pat. No. 5,474,234 (the '234 patent) issued to Maley on Dec. 12, 1995. The '234 patent describes a fluid valve assembly for controlling a high pressure fluid where the fluid valve assembly includes a non-resilient valve member and a non-resilient valve seat with a flat seating configuration. The non-resilient valve member has a concave end with an annular knife edge to sealingly engage a flat seating surface.

While the fluid valve assembly described in the '234 patent may be an improvement over the prior design because of its flat sealing surface, similar precision constraints may still be present in the manufacturing of a valve member with a concave end and an annular knife edge. In addition, the fluid valve assembly described in the '234 patent only has one seating surface, which may limit the placement of the fluid valve assembly within a fuel injector.

### SUMMARY

One aspect of the present disclosure is directed to a fuel injector. The fuel injector includes a nozzle member with a first end and a second end. The first end of the nozzle member has at least one orifice. The fuel injector also includes a control chamber located at the second end of the nozzle member. In addition, the fuel injector includes a drain passageway. The fuel injector further includes a needle valve element with a tip end configured to selectively block fluid flow through the at least one orifice, and a base end fluidly coupled to the control chamber. In addition, the fuel injector includes a control valve member with a first generally planar surface and a second opposing generally planar surface. The control valve is selectively movable between a first position and a second position. When the control valve is in the first position, the control chamber is fluidly block from the drain passageway. When the valve is in the second position, the control chamber is fluidly coupled to the drain passageway.

Another aspect of the present disclosure is directed to another fuel injector. This fuel injector includes a nozzle member with a first end and a second end. The first end of the nozzle member includes at least one orifice. The fuel injector also includes a control chamber located at the second end of the nozzle member. The fuel injector further includes a needle valve element with a tip end configured to selectively block fluid flow through the at least one orifice and a base end fluidly coupled to the control chamber. In addition, the fuel injector includes a drain, a closing passageway and a control valve that is fluidly coupled to the drain, the closing passageway, and the first end of the nozzle member. The control valve member includes substantially parallel first and second sealing surfaces that are configured to selectively open the drain and block the closing passageway.

### BRIEF DESCRIPTION OF THE DRAWINGS

FIG. 1 is a schematic and diagrammatic illustration of an exemplary disclosed fuel system;

FIG. 2 is a cross-sectional illustration of an exemplary disclosed fuel injector for use with the fuel system of FIG. 1; and

FIG. 3 is an exploded view of an exemplary disclosed actuator valve assembly for use with the fuel injector of FIG. 2.

### DETAILED DESCRIPTION

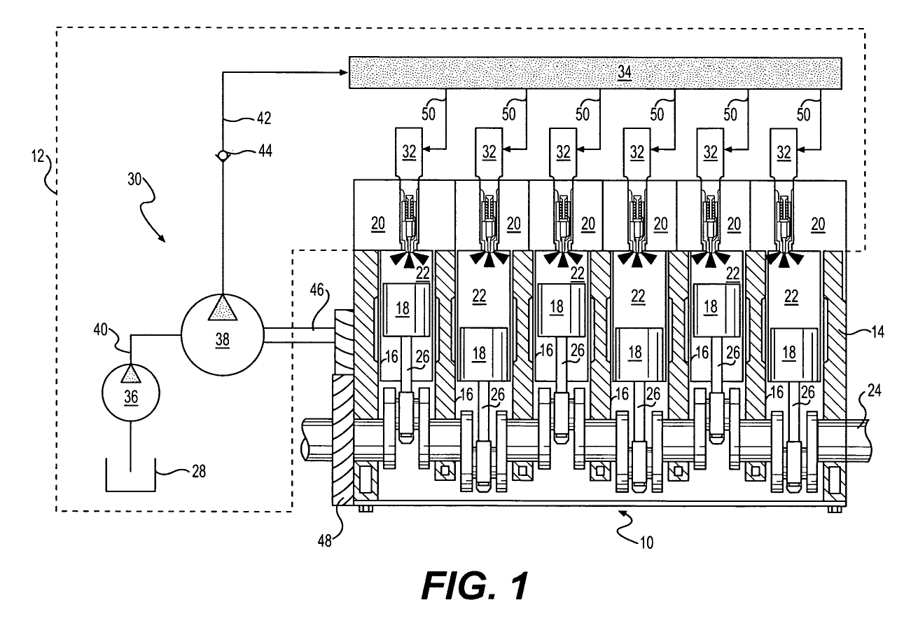

FIG. 1 illustrates an engine 10 and an exemplary embodiment of a fuel system 12. For the purposes of this disclosure, engine 10 is depicted and described as a four-stroke diesel engine. One skilled in the art will recognize; however, that engine 10 may be any other type of internal combustion engine such as, for example, a gasoline or a gaseous fuel-powered engine. Engine 10 may include an engine block 14 that at least partially defines a plurality of cylinders 16, a piston 18 slidably disposed within each cylinder 16, and a cylinder head 20 associated with each cylinder 16.

Cylinder 16, piston 18, and cylinder head 20 may form a combustion chamber 22. In the illustrated embodiment, engine 10 includes six combustion chambers 22. However, it is contemplated that engine 10 may include a greater or lesser number of combustion chambers 22 and that combustion chambers 22 may be disposed in an “in-line” configuration, a “V” configuration, or any other suitable configuration.

As also shown in FIG. 1, engine 10 may include a crankshaft 24 that is rotatably disposed within engine block 14. A connecting rod 26 may connect each piston 18 to crankshaft 24 so that a sliding motion of piston 18 within each respective cylinder 16 results in a rotation of crankshaft 24. Similarly, a rotation of crankshaft 24 may result in a sliding motion of piston 18.

Fuel system 12 may include components that cooperate to deliver injections of pressurized fuel into each combustion chamber 22. Specifically, fuel system 12 may include a tank 28 configured to hold a supply of fuel, and a fuel pumping arrangement 30 configured to pressurize the fuel and direct the pressurized fuel to a plurality of fuel injectors 32 by way of a common rail 34.

Fuel pumping arrangement 30 may include one or more pumping devices that function to increase the pressure of the fuel and direct one or more pressurized streams of fuel to common rail 34. In one example, fuel pumping arrangement 30 includes a low pressure source 36 and a high pressure source 38 disposed in series and fluidly connected by way of a fuel line 40. Low pressure source 36 may be a transfer pump configured to provide low pressure feed to high pressure source 38. High pressure source 38 may be configured to receive the low pressure feed and to increase the pressure of the fuel. High pressure source 38 may be connected to common rail 34 by way of a fuel line 42. A check valve 44 may be disposed within fuel line 42 to provide for unidirectional flow of fuel from fuel pumping arrangement 30 to common rail 34.

One or both of low and high pressure sources 36, 38 may be operably connected to engine 10 and driven by crankshaft 24. Low and/or high pressure sources 36, 38 may be connected with crankshaft 24 in any manner readily apparent to one skilled in the art where a rotation of crankshaft 24 will result in a corresponding rotation of a pump drive shaft. For example, a pump driveshaft 46 of high pressure source 38 is shown in FIG. 1 as being connected to crankshaft 24 through a gear train 48. It is contemplated; however, that one or both of low and high pressure sources 36, 38 may alternatively be driven electrically, hydraulically, pneumatically, or in any other appropriate manner.

Fuel injectors 32 may be disposed within cylinder heads 20 and connected to common rail 34 by way of a plurality of fuel lines 50. Each fuel injector 32 may be operable to inject an amount of pressurized fuel into an associated combustion chamber 22 at predetermined timings, fuel pressures, and fuel flow rates. The timing of fuel injection into combustion chamber 22 may be synchronized with the motion of piston 18. For example, fuel may be injected as piston 18 nears a top-dead-center position in a compression stroke to allow for compression-ignited-combustion of the injected fuel. Alternatively, fuel may be injected as piston 18 begins the compression stroke heading towards a top-dead-center position for homogenous charge compression ignition operation. Fuel may also be injected as piston 18 is moving from a top-dead-center position towards a bottom-dead-center position during an expansion stroke for a late post injection to create a reducing atmosphere for aftertreatment regeneration.

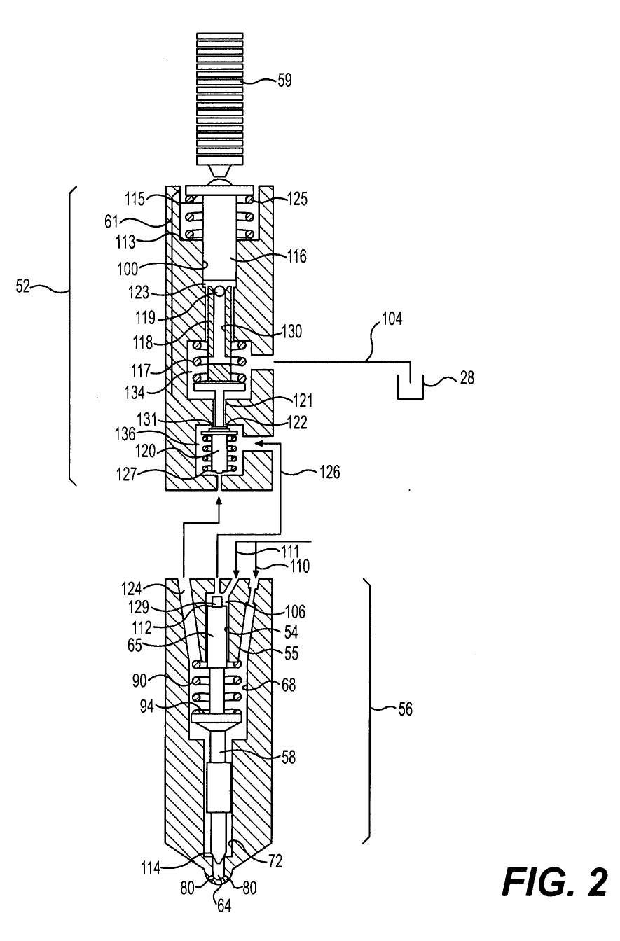

As illustrated in FIG. 2, each fuel injector 32 may embody a closed-nozzle unit connected to an injector body 52. Specifically, each fuel injector 32 may include injector body 52, a nozzle member 56, a guide 55 disposed within a nozzle member 56, a needle valve element or member 58 disposed within guide 55 and nozzle member 56, an actuator 59, and an actuator valve assembly 61 operatively connected between actuator 59 and needle valve element 58. A housing (not shown) may enclose one or more of the components of fuel injector 32.

Injector body 52 may embody a cylindrical member configured for assembly within cylinder head 20 and have one or more passageways. Specifically, injector body 52 may include a first chamber 134, a second chamber 136, a return passageway 126, a closing passageway 124, and an fuel outlet 104 or a drain. Return passageway 126 may fluidly communicate second chamber 136 with a control chamber 106 (discussed below); closing passageway 124 may fluidly communicate second chamber 136 with a first central bore 68 (discussed below); and outlet 104 may fluidly communicate tank 28 with first chamber 134. Injector body 52 may also include a central bore 100 configured to receive a portion of actuator valve assembly 61.

Nozzle member 56, which may be constructed from one or more individual pieces or elements, may likewise embody a cylindrical member having a first central bore 68 in communication with a second coaxial central bore 72. First central bore 68 may be configured to receive needle element 58, a return spring 90, and guide 55. Return spring 90 may be disposed between guide 55 and a seating surface 94 of needle element 58 to axially bias needle valve element 58 toward a tip end 64 of nozzle member 56. A first spacer (not shown) and a similar second spacer (also not shown) may be disposed between return spring 90 and seating surface 94 and between return spring 90 and guide 55, respectively, to reduce wear of these components. First central bore 68 may function as a pressure chamber and hold pressurized fuel from a supply passageway 110 in anticipation of an injection event. Second central bore 72 may be configured to receive needle valve element 58, and include one or more orifices 80 that pass pressurized fuel from first central bore 68 into combustion chambers 22 of engine 10, as needle valve element 58 is moved away from its seat. Nozzle member 56 may at least partially define supply passageway 110, closing passageway 124, and return passageway 126. Supply passageway 110 may fluidly communicate fuel line 50 (referring to FIG. 1) with first central bore 68 during operation of fuel injector 32. Control chamber 106 may be fluidly coupled to a base end 65 of needle valve element 58, and selectively drained of or supplied with pressurized fuel to control motion of needle valve element 58. Closing passageway 124 may fluidly communicate first central bore 68 with second chamber 136 (depending on the position of a control valve element 120 of actuator valve assembly 61).

Guide 55 may embody a cylindrical member having a central bore 54 for receiving base end 65 of needle valve element 58. Return passageway 126 and a supply passageway 111 may be disposed within guide 55. Return passageway 126 may fluidly communicate control chamber 106 with second chamber 136. Supply passageway 111 may fluidly communicate fuel line 50 (referring to FIG. 1) with control chamber 106 during operation of fuel injector 32. Needle valve element 58 may include a closing member 129 located at base end 65 configured to selectively block fluid communication between control chamber 106 and second chamber 136 (i.e. block return passageway 126) during an injection event.

Needle valve element 58 may be an elongated cylindrical member that is slidingly disposed within nozzle member 56 and guide 55. Needle valve element 58 may be axially movable between a first position at which a tip end of needle valve element 58 engages a corresponding seat surface to block a flow of fuel through orifices 80, and a second position at which the tip end is disengaged from the corresponding seating and orifices 80 are open to spray fuel into combustion chamber 22. In the second position, closing member 129 may block fuel flow through return passageway 126. It is contemplated that needle valve element 58 may be a multi-member element having a needle member and a piston member or a single integral element, if desired.

Needle valve element 58 may have multiple driving hydraulic surfaces. For example, needle valve element 58 may include a hydraulic surface 112 tending to drive needle valve element 58, with the bias of return spring 90, toward a first or orifice-blocking position when acted upon by pressurized fuel. Needle valve element 58 may also include a hydraulic surface 114 that opposes the bias of return spring 90 to drive needle valve element 58 in the opposite direction toward a second or orifice-opening position when acted upon by pressurized fuel.

Actuator 59 may include an electro-expansive module such as a piezo electric actuator. A piezo electric actuator may include one or more stacks of disk-type piezo electric crystals. The crystals may be structures with random domain orientations. These random orientations are asymmetric arrangements of positive and negative ions that exhibit permanent dipole behavior. When an electric field is applied to the stacks of crystals, such as, for example, by the application of a current, the stacks expand along the axis of the electric field as the domains line up.

Actuator 59 may be used to control the movement of needle valve element 58 by way of actuator valve assembly 61. Actuator valve assembly 61 may include a first piston 116, a second piston 118 spaced apart from first piston 116, and control valve element 120 movable by second piston 118. A check valve 119 may be disposed between first piston 116 and second piston 118 to provide unidirectional flow of fuel from first chamber 134, which surrounds second piston 118, to a coupling chamber 123.

First piston 116 may be connected to move with the expansion and retraction of actuator 59. Specifically, first piston 116 may be retained in mechanical engagement with the crystal stack of actuator 59 by way of a return spring 125. Return spring 125 may be disposed between a flange 115 of first piston 116 and a retaining surface 113. As actuator 59 is charged and expands or is de-energized and contracts, first piston 116 may move within central bore 100. It is contemplated that first piston 116 may be fixedly connected to actuator 59, if desired.

Second piston 118 may be separated from first piston 116 by a distance, thereby forming coupling chamber 123. As first piston 116 is moved toward nozzle member 56, the fluid within coupling chamber 123 urges second piston 118 downward against control valve element 120. In the present embodiment, first piston 116 has a larger diameter than second piston 118. As first piston 116 continues to move toward nozzle member 56, the location of coupling chamber 123 moves downward such that more of the overall volume of coupling chamber 123 is consumed within the smaller diameter region of second piston 118. As a result, the displacement of second piston 118 is magnified as compared to the displacement of first piston 116. When actuator 59 is de-energized, spring 125 urges first piston 116 away from nozzle member 56. At the same time, control valve element 120 urges second piston 118 away from nozzle member 56 back to its original position. A return spring 117 may be associated with second piston 118 to retain second piston 118 in contact with control valve element 120, if desired.

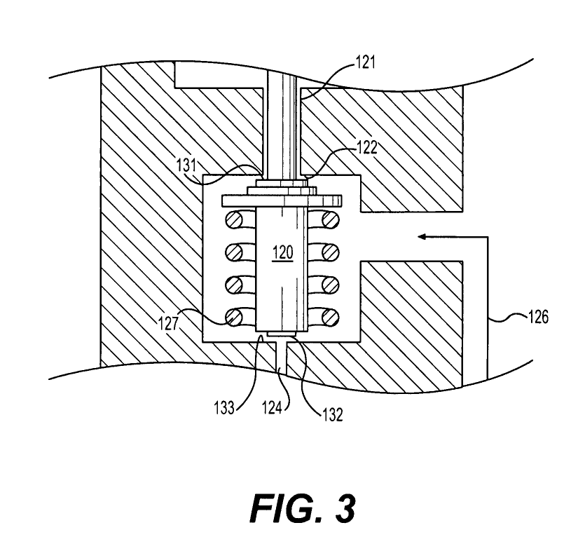

As illustrated in FIG. 3, control valve element 120 may include a generally planar first surface 131 that may be moved out of contact with a seat 122 against the bias of a return spring 127 to an injecting position. In the injecting position, control valve element 120 may fluidly couple control chamber 106, return passageway 126, second chamber 136, and a central bore 121 to fuel outlet 104 or a drain (not shown), thereby initiating injections of fuel. When first surface 131 is engaged with seat 122, or when control valve element 120 is in the non-injecting position, control chamber 106 is not allowed to drain through fuel outlet 104. Instead, fuel may flow from fuel line 50 (referring to FIG. 1) through supply passageway 111 to pressurize control chamber 106. As pressurized fuel builds within control chamber 106, the downward force generated at hydraulic surface 112, combined with the force of return spring 90, may overcome the upward force at hydraulic surface 114, thereby moving needle valve element 58 downward, closing orifices 80, and terminating fuel injection. Control valve element 120 may also include an opposing generally planar second surface 132 that is moved into and out of contact with a seat 133 to selectively block fluid flow from first central bore 68 when control valve element 120 is in the injecting position and to open second chamber 136 to first central bore 68 when control valve element 120 is in the non-injecting position. First surface 131 and second surface 132 generally work opposite one another, except when control valve element 120 is moving between injecting position and non-injecting position where only one of seats 122 and 133 may be engaged. As fuel from control chamber 106 drains to tank 28 (referring to FIG. 2), the upward force applied by the pressurized fuel at hydraulic surface 114 may urge needle valve element 58 upward against the bias of return spring 90, thereby opening orifices 80 and initiating fuel injection into combustion chambers 22. The de-energization of actuation 59, together with the pressure of fluid from return passageway 124 acting on second surface 132 help to return control valve element 120 to the non-injecting position.

### INDUSTRIAL APPLICABILITY

The fuel injector of the present disclosure has wide application in a variety of engine types including, for example, diesel engines, gasoline engines, and gaseous fuel-powered engines. The disclosed fuel injector may be implemented into any engine where low cost, efficiency, and ease of manufacturing may be important. Operation of fuel injectors 32 will now be described.

Needle valve element 58 may be moved by an imbalance of force generated by fuel pressure. For example, when needle valve element 58 is in the first or orifice-blocking position, pressurized fuel from fuel supply passageway 111 may flow into control chamber 106 to act on hydraulic surface 112. Simultaneously, pressurized fuel from fuel supply passageway 110 may flow into first central bore 68 and second central bore 72 in anticipation of injection. The force of spring 90, combined with the force generated at hydraulic surface 112, may be greater than an opposing force generated at hydraulic surface 114, thereby causing needle valve element 58 to remain in the first position to restrict fuel flow through orifices 80.

To open orifices 80 and inject the pressurized fuel from second central bore 72 into combustion chamber 22, current may be sent to actuator 59 causing an expansion that moves first piston 116 toward nozzle member 56. As first piston 116 moves toward coupling chamber 132, the fluid within coupling chamber 132 may act to move second piston 118 in a manner that amplifies the displacement of second piston 118 relative to first piston 116. The movement of second piston 118, in turn, engages control valve element 120 and moves it into the injecting position. In the injecting position, control chamber 106 is fluidly coupled to tank 28, which has the effect of decreasing the pressure within control chamber 106 that acts upon surface 112. In addition, when second piston 118 engages and moves control valve element 120 into the injecting position, opposing generally planar second surface 132 may engage seat 133 thereby blocking closing passageway 124. The blocking of closing passageway 124 closes off first central bore 68 from tank 28, which in turn helps to reduce any pressure loss within first central bore 68. The decrease in pressure acting on hydraulic surface 112 creates a situation in which the force acting upon hydraulic surface 114 is greater than the combination of the force acting upon hydraulic surface 112 and the biasing force provided by spring 90. When this occurs, needle valve element 58 will move toward the orifice-opening position.

To close orifices 80 and end the injection of fuel into combustion chamber 22, actuator 59 may be de-energized. As the stack of piezo crystals within actuator 59 contract, first piston 116 may move back upward to its original position. This allows spring 127 and the force resulting from the pressure acting on surface 132 of control valve element 120 to return control valve element 120 to its non-injecting position and to return second piston 118 to its original position. When control valve element 120 is in the non-injecting position, fuel from control chamber 106 may be inhibited from draining to tank 28. Because pressurized fuel is continuously supplied to control chamber 106 via supply passageway 111, pressure may rapidly build up within control chamber 106 when drainage therefrom is inhibited. The increasing pressure within control chamber 106 corresponds to an increasing pressure on hydraulic surface 112. The increase in pressure acting on hydraulic surface 112 will create a situation in which the combination of the force acting upon hydraulic surface 112 and the biasing force provided by spring 90 becomes greater than the force acting upon hydraulic surface 114. When this occurs, needle valve element 58 will move toward the closed position.

The generally planar surfaces 131 and 132 of control valve element 120 may allow easy setting and measurement of the valve lift. Also, control valve element 120 with two opposing generally planar surfaces, may be relatively easy and inexpensive to manufacture. Furthermore, control element 120 with two opposing generally planar surfaces may be used in fuel injectors where three-way control of pressurized fluid is desired.

It will be apparent to those skilled in the art that various modifications and variations can be made to the fuel injector of the present disclosure without departing from the scope of the disclosure. Other embodiments will be apparent to those skilled in the art from consideration of the specification and practice of the control system disclosed herein. It is intended that the specification and examples be considered as exemplary only, with a true scope of the disclosure being indicated by the following claims and their equivalents.

1. A fuel injector, comprising:
a nozzle member having a first end with at least one orifice, and a second end;
a drain passageway;
a control chamber located at the second end of the nozzle member;
a needle valve having a tip end configured to selectively block fluid flow through the at least one orifice, and a base end fluidly coupled to the control chamber; and
a control valve having a first generally planar sealing surface and a second opposing generally planar sealing surface and selectively movable between a first position and a second position, wherein in the first position the control chamber is fluidly blocked from the drain passageway and in the second position the control chamber is fluidly coupled to the drain passageway.

2. The fuel injector of claim 1, wherein the first and second generally planar sealing surfaces are substantially parallel.

3. The fuel injector of claim 1, further including a piezo actuator configured to move the control valve.

4. The fuel injector of claim 1, further including a closing passageway disposed within the nozzle member, between the control valve and the first end of the nozzle member, the first generally planar sealing surface being configured to selectively block the closing passageway during an injection event.

5. The fuel injector of claim 4, wherein the second generally planar sealing surface moves to allow fluid flow from the control chamber to a drain during the injection event.

6. The fuel injector of claim 1, further including:
a first passageway fluidly coupling the tip end of the needle valve with a high pressure source;
a second passageway fluidly coupling the control chamber with the high pressure source; and
a third passageway fluidly coupling the control chamber and the control valve.

7. The fuel injector of claim 1, further including:
an injector body;
a first piston located within the injector body and operatively connected to the control valve to move the control valve;
a second piston located within the injector body a distance from the first piston to form a coupling chamber; and
a check valve associated with the coupling chamber and movable to selectively replenish the coupling chamber.

8. A fuel injector, comprising:
a nozzle member having a first end with at least one orifice, and a second end;
a control chamber located at the second end of the nozzle member;
a needle valve having a tip end configured to selectively block fluid flow through the at least one orifice, and a base end fluidly coupled to the control chamber;
a drain;
a closing passageway; and
a control valve configured to selectively fluidly couple the control chamber with the drain or the first end of the nozzle member, the control valve having substantially parallel first and second sealing surfaces configured to selectively open the drain and block the closing passageway.

9. The fuel injector of claim 8, wherein the first sealing surface is configured to selectively block fluid flow from the closing passageway during an injection event.

10. The fuel injector of claim 8, further including a return passageway fluidly coupling the second end of the nozzle member with the control valve.

11. The fuel injector of claim 10, wherein fluid flow in the return passageway is substantially perpendicular to fluid flow in the closing passageway.

12. The fuel injector of claim 10, wherein the second sealing surface moves to allow fluid flow from the return passageway during an injection event.

13. The fuel injector of claim 8, wherein the control valve is configured to alternatingly open the drain and block the closing passageway.

14. The fuel injector of claim 8, further including:
an injector body;
a first piston located within the injector body and operatively connected to the control valve to move the control valve;
a second piston located within the injector body a distance from the first piston to form a coupling chamber; and
a check valve associated with the coupling chamber to selectively replenish the coupling chamber.

15. A fuel system, comprising:
a source of pressurized fuel;
a common rail connected to receive pressurized fuel from the source of pressurized fuel; and
a fuel injector configured to receive and inject the pressurized fuel from the common rail, the fuel injector including:
a nozzle member having a first end with at least one orifice, and a second end;
a control chamber located at the second end of the nozzle member;
a needle valve having a tip end configured to selectively block fluid flow through the at least one orifice, and a base end fluidly coupled to the control chamber; and
a control valve having a first generally planar surface and a second opposing generally planar surface and selectively movable between a first position and a second position, wherein in the first position the control chamber is fluidly blocked from the drain passageway and in the second position the control chamber is fluidly coupled to the drain; and
first and second control valve seats configured to engage the first and second generally planar surfaces, respectively.

16. The fuel system of claim 15, further including a fluid passageway configured to selectively drain fuel from the control chamber.

17. The fuel system of claim 15, further including a fluid passageway configured to selectively supply fuel to the control chamber.

18. The fuel system of claim 15, wherein the first and second generally planar surfaces are substantially parallel.

19. The fuel system of claim 15, wherein the fuel injector further comprises:
an injector body;
a first piston located within the injector body and operatively connected to the control valve to move the control valve;
a second piston located within the injector body a distance from the first piston to form a coupling chamber; and
a check valve associated with the coupling chamber and movable to selectively replenish the coupling chamber.
